(19) United States
(12) Patent Application Publication
(10) Pub. No.: US 2013/0073796 A1
(43) Pub. Date: Mar. 21, 2013

(54) MEMORY CONTROLLER

(71) Applicant: Shinji MAEDA, Kawasaki-shi (JP)

(72) Inventor: Shinji MAEDA, Kawasaki-shi (JP)

(21) Appl. No.: 13/428,158

(22) Filed: Mar. 23, 2012

(30) Foreign Application Priority Data
Sep. 20, 2011 (JP) 2011-205198

(51) Int. Cl. G06F 12/02

(52) U.S. Cl. 711/103; 711/E12.008

(57) ABSTRACT

According to one embodiment, a memory controller includes a first interface, a second interface, and a control module. The first interface transmits and receives a signal to and from a host. The second interface transmits and receives a signal to and from a nonvolatile semiconductor memory. The control module reserves a spare area in the semiconductor memory in response to a first command received by the first interface and writes update data into the spare area when updating data in the semiconductor memory. Size of the spare area is available according to the first command.

### CROSS-REFERENCE TO RELATED APPLICATIONS

This application is based upon and claims the benefit of priority from prior Japanese Patent Application No. 2011-205198, filed Sep. 20, 2011, the entire contents of which are incorporated herein by reference.

### FIELD

Embodiments described herein relate generally to a memory controller.

### BACKGROUND

Various studies are being made to increase the number of times data can be rewritten in a NAND flash memory.

### BRIEF DESCRIPTION OF THE DRAWINGS

FIG. 1 is a block diagram of a memory system according to a first embodiment;

FIGS. 2 and 3 are conceptual diagrams of a memory space according to the first embodiment;

FIG. 4 is a flowchart to explain the operation of a memory controller according to the first embodiment;

FIG. 5 is a conceptual diagram of a memory space according to the first embodiment;

FIG. 6 is a conceptual diagram of an allowable-number-of-rewrites table according to a second modification of the first embodiment;

FIG. 7 is a flowchart to explain the operation of a memory controller according to the second modification of the first embodiment;

FIG. 8 is a conceptual diagram of a number-of-writes table according to a second embodiment;

FIG. 9 is a flowchart to explain the operation of a memory controller according to the second embodiment;

FIG. 10 is a conceptual diagram of a memory space according to the third embodiment;

FIG. 11 is a flowchart to explain the operation of a memory controller according to a fourth embodiment; and

FIGS. 12 and 13 are conceptual diagrams of a memory space according to the fourth embodiment.

### DETAILED DESCRIPTION

In general, according to one embodiment, a memory controller includes a first interface, a second interface, and a control module. The first interface transmits and receives a signal to and from a host. The second interface transmits and receives a signal to and from a nonvolatile semiconductor memory. The control module reserves a spare area in the semiconductor memory in response to a first command received by the first interface and writes update data into the spare area when updating data in the semiconductor memory.

### First Embodiment

A memory controller according to a first embodiment will be explained. Hereinafter, an explanation will be given, taking a memory controller that controls a NAND flash memory as an example.

1. Configuration of Memory System

1.1 Overall Configuration of Memory System

First, the configuration of a memory system including a memory controller according to the first embodiment will be explained.

As shown in FIG. 1, the memory system 1 includes a host device 10, a memory controller 20, and a NAND flash memory 30.

The host device 10 issues an instruction to the memory controller 20, thereby accessing the NAND flash memory 30. Then, by way of the memory controller 20, the host device 10 writes data into the NAND flash memory 30, reads data from the NAND flash memory 30, or erases data in the NAND flash memory 30. The host device 10 is, for example, a personal computer, a digital camera, or a mobile phone.

In response to an instruction from the host device 10, the memory controller 20 instructs the NAND flash memory 30 to read, write, or erase data. The memory controller 20 also manages a memory space of the NAND flash memory 30.

The NAND flash memory 30 holds data in a nonvolatile manner. The NAND flash memory includes a plurality of memory cells. Each of the memory cells, which has a gate obtained by stacking a charge accumulation layer and a control gate one on top of the other, holds data in a nonvolatile manner. In the NAND flash memory 30, data is erased in blocks. A block is a set of a plurality of memory cells.

The memory controller 20 and NAND flash memory 30 may be included in one product like a memory card, such as an SD™ card or a solid-state drive (SSD).

1.2 Configuration of Memory Controller 20

Next, a configuration of the memory controller 20 will be explained with reference to FIG. 1. As shown in FIG. 1, the memory controller 20 comprises a host interface circuit 21, an embedded memory 22, a memory interface circuit 23, and a processor (CPU) 24.

The host interface circuit 21, which is connected to the host device 10 via a host interface, controls communication with the host device 10. The host interface circuit 21 transfers an instruction and data received from the host device 10 to the CPU 24 and embedded memory 22, respectively. In response to an instruction from the CPU 24, the host interface circuit 21 transfers data in the embedded memory 22 to the host device 10.

The embedded memory 22, which is a semiconductor memory, such as a NOR flash memory DRAM, temporarily holds data transferred from the host interface circuit 21 and memory interface circuit 23. The embedded memory 22 further holds information (including firmware and various tables) necessary to manage the NAND flash memory 30.

The CPU 24 controls the operation of the entire memory controller 20. For example, when having received a write instruction from the host device, the CPU 24 issues a write instruction compliant with a memory interface (in this case, a NAND interface). The same holds true when reading or erasing is done. In addition, the CPU 24 executes various processes to manage the NAND flash memory 30, such as ware leveling.

The memory interface circuit 23, which is connected to the NAND flash memory 30 via a memory interface, controls communication with the NAND flash memory 30. The memory interface circuit 23 transfers an instruction received from the CPU 24 to the NAND flash memory 30 or transfers write data in the embedded memory 22 to the NAND flash memory 30 in a write operation. Further in a read operation, the CPU 24 transfers data read from the NAND flash memory 30 to the embedded memory 22.

1.3 Management of NAND Flash Memory 30

Next, management of the NAND flash memory 30 by the memory controller 20 with the above configuration will be explained.

1.3.1 Normal Management

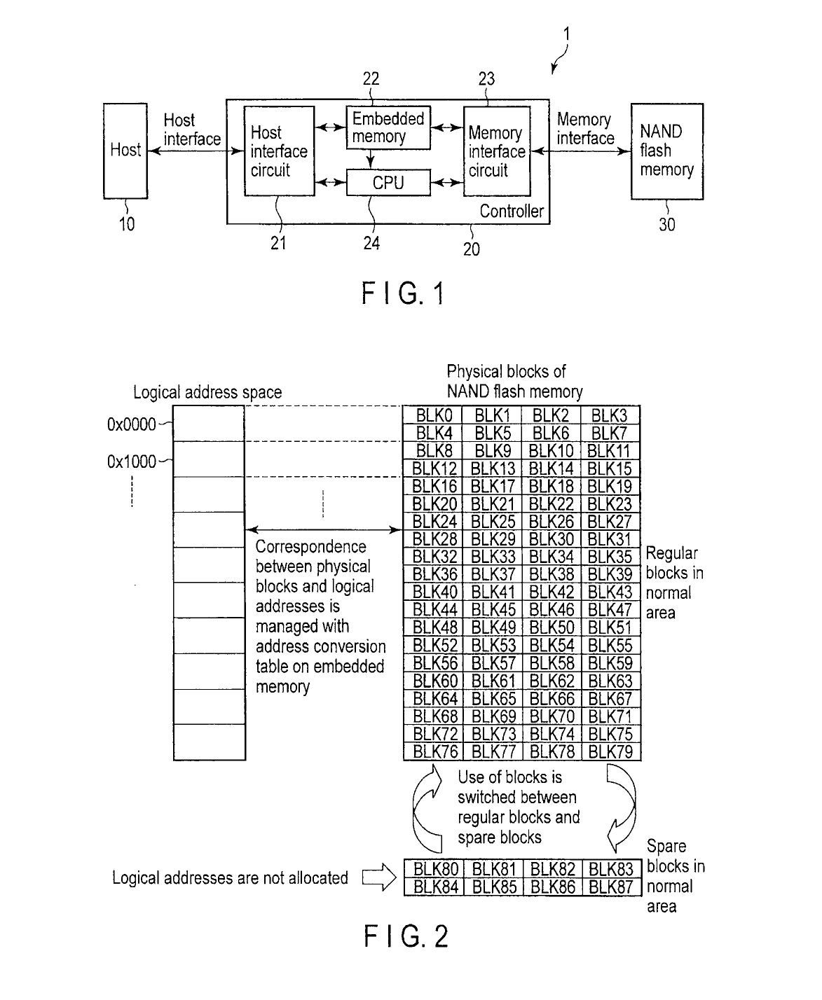

FIG. 2 is a schematic diagram showing the relationship between a memory space (a logical address space) of the NAND flash memory 30 viewed from the host device 10 and blocks (also referred to as “physical blocks” in contrast with a logical address space) of the NAND flash memory.

The host device 10 accesses the NAND flash memory 30 by use of logical addresses. The physical blocks (or physical addresses) in the NAND flash memory 30 are associated with logical addresses. The correspondence between the logical addresses and physical addresses is frequently changed when data is updated. Accordingly, the CPU 24 manages the correspondence relationship between the logical addresses and physical addresses by use of a table. Hereinafter, the table is called an address conversion table. The address conversion table is held in, for example, the embedded memory 22 and NAND flash memory 30.

In the example of FIG. 2, the NAND flash memory 30 includes 88 physical blocks BLK (BLK0 to BLK87). Of course, this number is only one example and is arbitrary. Also in the example of FIG. 2, a logical address space starting with 0x0000 corresponds to eight physical blocks BLK0 to BLK7 and a logical space starting with 0x1000 corresponds to eight physical blocks BLK8 to BLK15. Of course, this correspondence relationship is also only one example.

The CPU 24 of the memory controller 20 manages the 88 physical blocks by dividing them into regular blocks and spare blocks. In the example of FIG. 2, physical blocks BLK0 to BLK79 are regular blocks and physical blocks BLK80 to BLK87 are spare blocks.

Logical addresses are allocated to the regular blocks. Therefore, the regular blocks are the areas that can be accessed by the host device 10. Data is written to, read from, or erased from the regular blocks under the control of the host device 10.

In contrast, logical addresses are not allocated to the spare blocks. The host device 10 cannot access the spare blocks directly. The spare blocks are used when data in the regular blocks is updated or erased.

For example, consider a case where data in physical block BLK0 is updated. In this case, update data is written into block BLK80, not into block BLK0 (at this time, data not to be updated in physical block BLK0 is also copied together into block BLK80). Then, a logical address is allocated to physical block BLK80, which is turned into a regular block. The allocation of a logical address to physical block BLK0 is cancelled. That is, the logical address space to which physical block BLK0 was correlated until then is replaced with physical block BLK80. Then, physical block BLK0 is turned into a spare block. Thereafter, when some data in a regular block is updated, spare blocks BLK81, BLK82, . . . are used in sequence similarly.

The CPU 24 manages the NAND flash memory 30 as described above, thereby preventing accesses from concentrating on a specific physical block.

1.3.2 Management in Providing an Expanded Area

The memory controller 20 can set an expanded area in a memory space of the NAND flash memory 30 according to an instruction from the host device 10. An expanded area is an area of a specific memory space to which a characteristic differing from that of the remaining memory space has been given. The expanded area is provided with a higher reliability or a higher performance. Hereinafter, to distinguish the expanded area from the rest, the area excluding the expanded area is called a normal area.

One example of the expanded area is an area where i bit (i being an integer greater than or equal to one) of data is written in a memory cell. One example of the normal area is an area where (i+1) bits of data is written in a memory cell. Hereinafter, explanation will be given, taking a case where i=1 as an example. That is, a memory cell in the normal area can hold 2-bit (4-level) data and a memory cell in the expanded area can hold 1-bit (2-level) data.

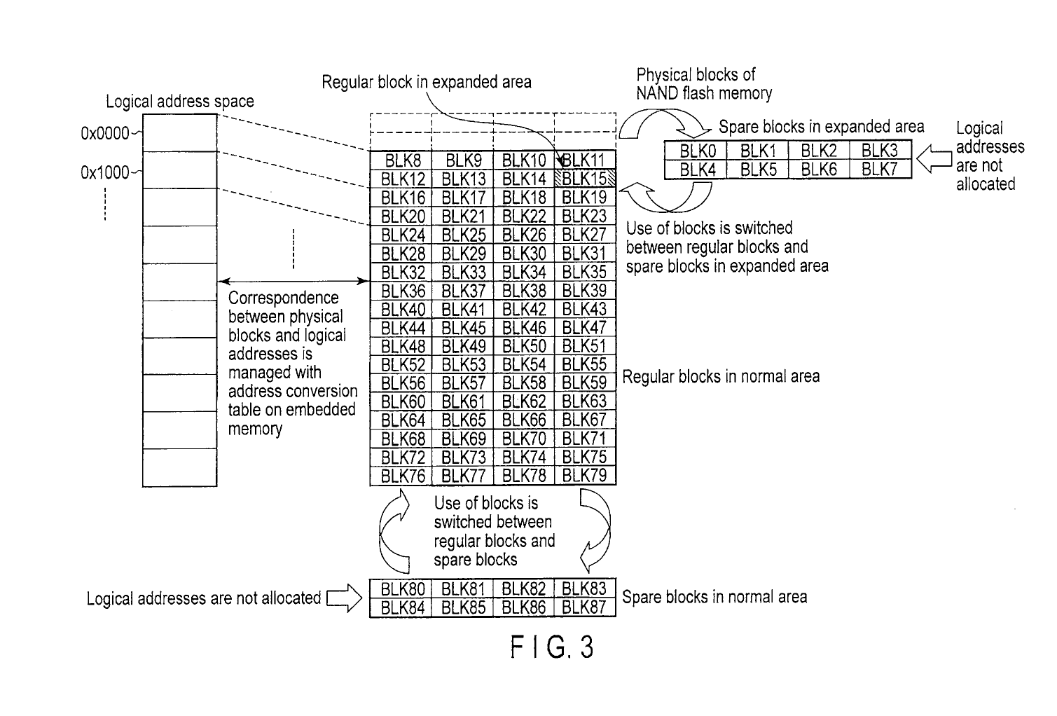

FIG. 3 shows a case where an expanded area is set using physical block BLK15 in the NAND flash memory explained in FIG. 2.

As shown in FIG. 3, the CPU 24 sets physical block BLK15 in an expanded area and reserves physical blocks BLK0 to BLK7 as spare blocks for expanded areas. Of course, logical addresses are not allocated to physical blocks BLK0 to BLK7 unless they are replaced with regular blocks. The CPU 24 writes data in physical blocks BLK0 to BLK7, and BLK15 in two levels and in the other physical blocks in 4 levels. Although writing data in two levels makes the logical address space half that when data is written in 4 levels, this is ignored in the accompanying drawings of the embodiment to simplify the explanation.

2. Operation of Memory System

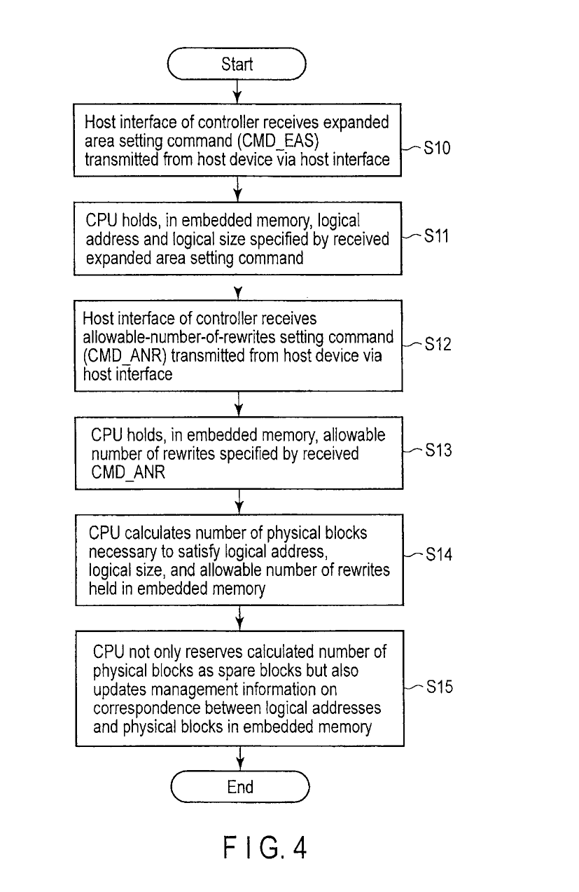

Next, the operation of the memory controller 20 particularly in setting an expanded area in the memory system 1 with the above configuration will be explained. FIG. 4 is a flowchart to explain the operation of the memory controller 20.

As shown in FIG. 4, first, the memory controller 20 causes the host interface circuit 21 to receive an expanded area setting command (CMD_EAS) transmitted via the host interface from the host device 10 (step S10). The CMD_EAS includes information indicating a logical address and a logical size. The logical address represents an initial address in a logical address space of an area serving as an expanded area. The logical size represents a size (capacity) of an expanded area in a logical address space.

Then, the CPU 24 causes the embedded memory 22 to hold the logical address and the logical size specified by the CMD_EAS (step S11).

Next, the memory controller 20 causes the host interface circuit 21 to receive an allowable-number-of-rewrites setting command (CMD_ANR) transmitted via the host interface from the host device 10 (step S12). The CMD_ANR includes information that indicates the maximum possible number of rewrites (also referred to as the allowable number of rewrites) required for an expanded area set by the CMD_EAS received in step S10.

Then, the CPU 24 causes the embedded memory 22 to hold the allowable number of rewrites specified by the CMD_ANR (step S13).

Next, the CPU 24 calculates the number of spare blocks for an expanded area necessary to satisfy the logical address, logical size, and the allowable number of rewrites held in the embedded memory 22 (step S14). At this time, the CPU 24 calculates the number of spare blocks N on the basis of the following equation (1):

X=A(C−B)/B (1)

where A is the number of regular blocks (proportional to the logical size) in the expanded area, B is the allowable number of rewrites per physical block (hereinafter, referred to as an ability value, being a fixed value), C is the allowable number of rewrites required for the expanded area, and C>B holds.

Then, of the regular blocks in the normal area, the CPU 24 sets as many physical blocks as are necessary as regular blocks in the expanded area and further sets as many physical blocks as are calculated in step S14 as spare blocks in the expanded area (step S15). This changes the correspondence relationship between the logical addresses and the physical blocks. Therefore, the CPU 24 updates the address conversion table so as to reflect the change of the correspondence relationship.

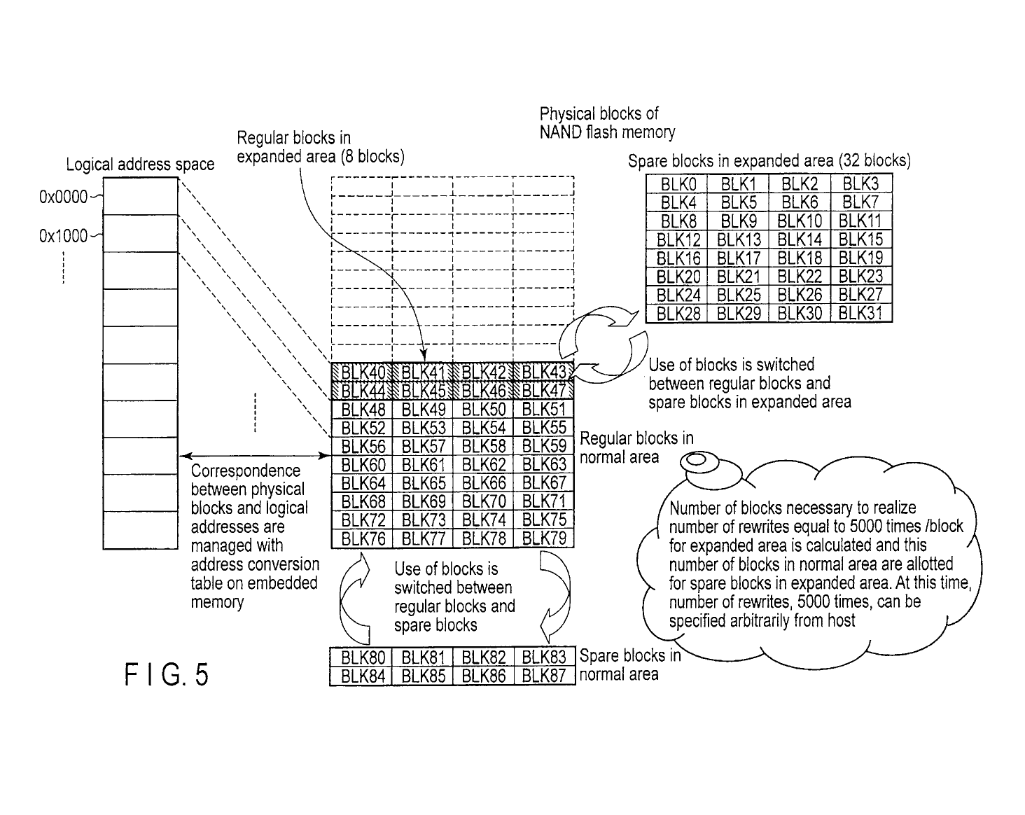

FIG. 5 is a schematic diagram showing the relationship between the logical addresses and the physical blocks, representing a specific example of the above method.

For example, suppose the logical address specified in step S11 corresponds to physical block BLK40 and the logical size corresponds to a capacity of eight physical blocks. In addition, suppose the allowable number of rewrites specified in step S12 is 5000 times. The 5000 times is the maximum possible number of rewrites required for each physical block on the assumption that spare blocks are used.

Moreover, suppose the maximum possible number of rewrites (an ability value) per physical block is 1000 times. The ability value is not based on the assumption that spare blocks are used. It is the net possible number of rewrites for each physical block. Then, in step S14, the CPU 24 determines that the necessary number of spare blocks is 32 from X=8×(5000−1000)/1000=32.

Accordingly, in step S15, the CPU 24 sets eight physical blocks BLK40 to BLK 47 as regular blocks in the expanded area and, for example, 32 physical blocks BLK0 to BLK31 as spare blocks in the expanded area.

This enables eight regular blocks in the expanded area to be used in sequence together with the 32 spare blocks, which makes it possible to rewrite an expanded area of the eight physical blocks 5000 times per regular block. In other words, use of the 32 spare blocks enables an expanded area of eight physical blocks to be rewritten 40,000 times.

3. Effects of the First Embodiment

As described above, the configuration of the first embodiment enables a semiconductor memory to be used efficiently.

Hereinafter, the effects will be explained in detail.

When a NAND flash memory is managed, for example, an area written into in two levels and an area written into in four levels are distinguished from each other and important information is written in two levels, which enables the reliability of important data to be maintained, while securing a large capacity.

At this time, spare blocks are provided for each area. Then, the used of blocks is switched between the regular blocks and the spare blocks, which prevents accesses from concentrating on a specific physical block and therefore enables the number of times the expanded area is rewritten to be increased sufficiently.

In the first embodiment configured as described above, the number of spare blocks in the expanded area is made variable. Specifically, the CPU 24 calculates the optimum number of blocks on the basis of the expanded area size requested by the host device 10 and the allowable number of rewrites, and reserves the number. Therefore, it is possible to fulfill both the expanded area size and the allowable number of rewrites.

If the number of spare blocks in the expanded area is constant, such an effect has not been obtained. For example, suppose the number of spare blocks is always eight and the maximum possible number of rewrites per physical block is 1000 times.

Then, if the number of regular blocks in the expanded area is eight, the total allowable number of rewrites in the expanded area is:

(8 [number of regular blocks]+8 [number of spare blocks])×1,000 (allowable number of rewrites/block)=16,000 times

Converting this into the allowable number of rewrites per regular block gives:

16,000 times/8 (number of regular blocks)=2,000 times

Therefore, the allowable number of rewrites is 2,000 times. If the number of regular blocks in the expanded area is one, the total allowable number of rewrites in the expanded area is:

(1 [number of regular blocks]+8 [number of spare blocks]×1,000 (allowable number of rewrites/block)=9,000 times

Converting this into the allowable number of rewrites per regular block gives:

9,000 times/1 (number of regular blocks)=9,000 times

That is, the allowable number of rewrites varies, depending on the size of the expanded area. The larger the number of regular blocks, the smaller the allowable number of rewrites. Therefore, the necessary allowable number of rewrites might not be satisfied. Alternatively, the allowable number of rewrites might be too large.

In the first embodiment, as the size of the expanded area becomes larger (that is, as the number of regular blocks in the expanded area increases) and the allowable number of rewrites required increases, more spare blocks are reserved. At this time, an excessively large number of spare blocks are not reserved and an optimum number of spare blocks are reserved. Therefore, the allowable number of rewrites required for the expanded area can be satisfied and an excessive number of spare blocks are prevented from being secured and therefore they are prevented from being used wastefully.

Of course, the larger the number of spare blocks, the smaller the number of physical blocks used as regular blocks in the normal area decreases. Therefore, the CPU 24 may set the maximum number of spare blocks and reserve spare blocks in a range less than or equal to the maximum number.

4. Modifications of the First Embodiment

4.1 First Modification

In the first embodiment, the memory controller 20 receives an expanded area setting command CMD_EAS and an allowable-number-of-rewrites setting command CMD_ANR separately. However, the memory controller 20 may receive a single command into which the two commands CMD_EAS and CMD_ANR have been put together. That is, one command may include an instruction to set an expanded area, a logical address, a logical size, and the allowable number of rewrites.

4.2 Second Modification

In the first embodiment, the memory controller 20 receives the allowable number of rewrites data by the allowable-number-of-rewrites setting command CMD_ANR. The memory controller 20 need not necessarily receive the allowable number of rewrites itself and may receive any information, provided that the information indicates the allowable number of rewrites.

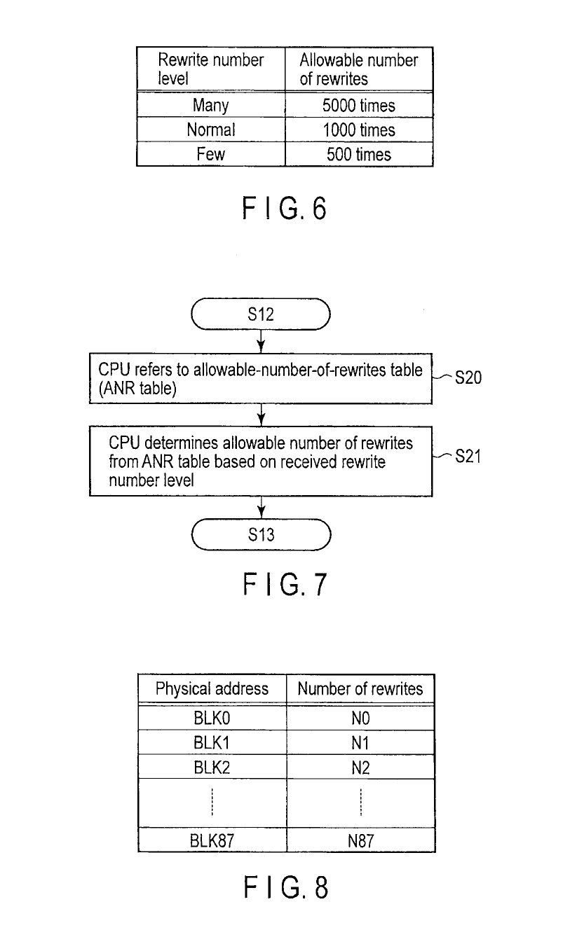

For example, instead of the allowable number of rewrites itself, rewrite number level information, such as “many,” “normal,” or “few,” may be used. In such a case, the memory controller 20 holds, for example, a allowable-number-of-rewrites table (ANR table) as shown in FIG. 6 in the embedded memory 22. As shown in FIG. 6, the ANR table holds information on the allowable number of rewrites according to each level. FIG. 7 shows the operation of the memory controller 20 in this case. As shown in FIG. 7, after step S12, the CPU 24 refers to the ANR table (step S20). Then, the CPU 24 determines the allowable number of rewrites from the ANR table on the basis of the received number-of-rewrites level (step S21). Thereafter, control proceeds to step S13.

As another method, instead of the allowable number of rewrites, the number of spare blocks necessary to secure the necessary allowable number of rewrites may be specified directly by the CMD_ANR.

4.3 Third Modification

In the first embodiment, the explanation has been given, taking as an example a case where ability value B of the allowable number of rewrites per physical block is a fixed value. Ability value B has been held in, for example, the embedded memory 22.

However, by the CMD_EAS, the CMD_ANR, or another command, ability value B may be received from the host device 10 and the CPU 24 may calculate equation (1) using the received ability value B.

Ability value B of the NAND flash memory 30 is likely to change, depending on its generation. Therefore, even if a certain ability value B is suitable for a certain product, it may not be suitable for another product. Therefore, it is desirable that the most suitable ability value B should be received from the host device 10.

### Second Embodiment

Next, a memory controller according to a second embodiment will be explained. The second embodiment is such that rewriting is inhibited when the number of rewrites has reached its upper limit (or the allowable number of rewrites) in the first embodiment or the modifications of the first embodiment. Hereinafter, only what differs from the first embodiment will be explained.

1. Number-of-Writes Table

A memory controller 20 according to the second embodiment holds a number-of-writes table in an embedded memory. FIG. 8 is a conceptual diagram of the number-of-writes table. As shown in FIG. 8, the number-of-writes table holds the number of writes Nj for each physical block BLKj (j being a natural number). Each time writing is done, the number-of-writes table is updated.

2. Operation of Memory Controller 20

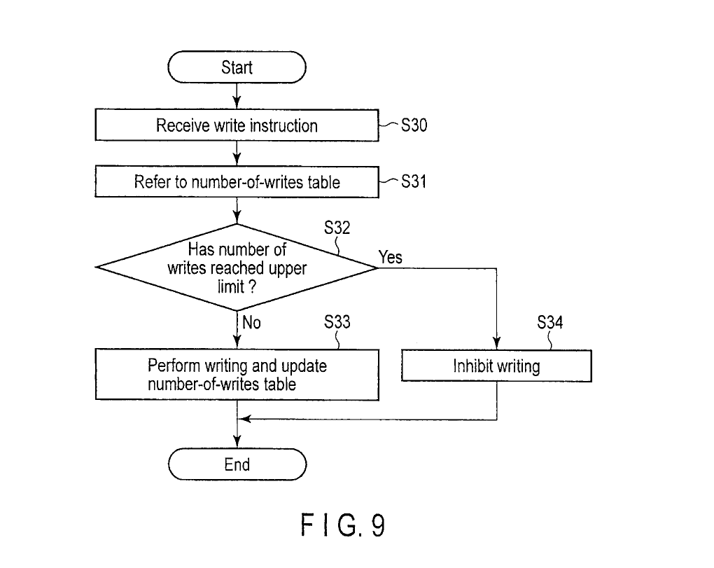

FIG. 9 is a flowchart to explain the operation of the memory controller 20 when receiving a write instruction from the host device 10.

As shown in FIG. 9, when having received a write instruction (step S30), the CPU 24 refers to the number-of-writes table (step S31). Then, the CPU 24 determines whether the number of writes of a physical block (a regular block in an expanded area) to be written into has reached the upper limit (or the allowable number of rewrites). If the number has not reached the upper limit (No in step S32), the CPU 24 performs writing and updates the number-of-writes table (step S33). If the number has reached the upper limit (Yes in step S32), the CPU 24 inhibits writing (step S34). Then, the CPU 24 sends back a write error to the host device 10.

3. Effects of the Second Embodiment

A physical block whose number of rewrites has reached the allowable number of rewrites as a result of rewriting data repeatedly might have a decreased reliability of data writing and data storage.

Therefore, inhibiting data in such a physical block from being updated makes it possible to prevent write errors or data loss from taking place. In addition, limiting the number of rewrites contributes to maintaining the security of data.

When the determination has shown YES in step S32 for the first time, a flag may be set in a corresponding entry of the rewrite table. Then, when having been accessed for writing, the CPU 24 checks the flag of the corresponding physical block and may not perform rewriting if the flag has been set. By use of the flag, the CPU 24 need not perform the comparing process in step S32 each time.

### Third Embodiment

Next, a memory controller according to a third embodiment will be explained. The third embodiment is such that a plurality of expanded areas are provided in the first embodiment, the modifications of the first embodiment, or the second embodiment. Hereinafter, only what differs from the first embodiment will be explained.

1. Setting of a Plurality of Expanded Areas

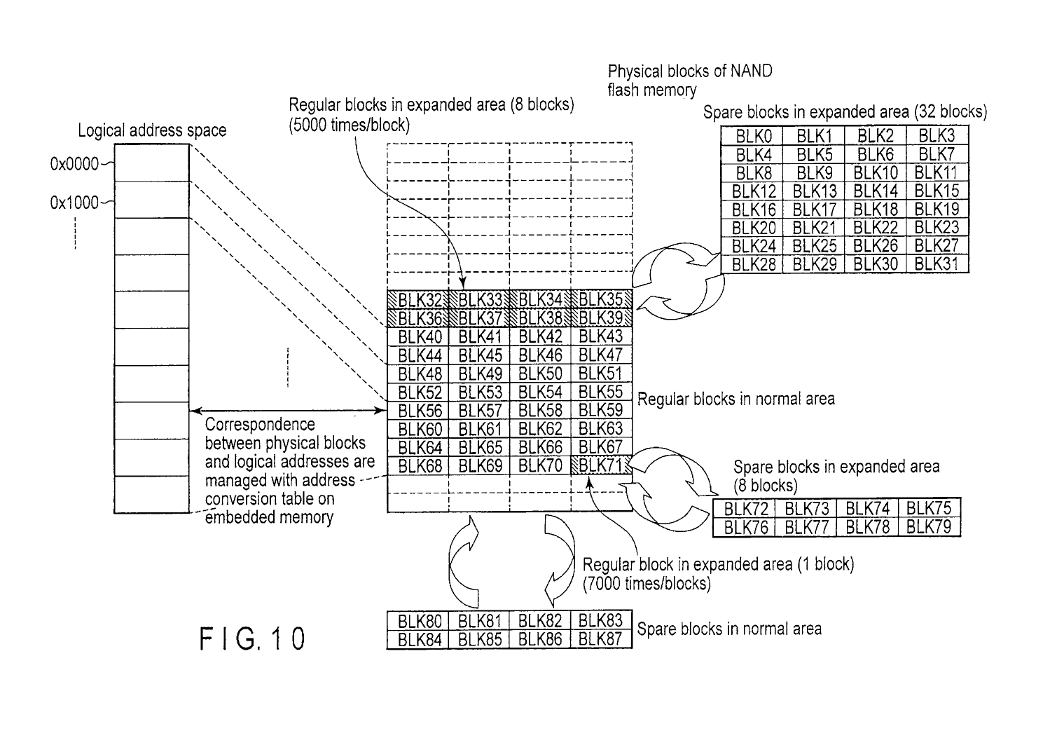

A plurality of expanded areas are provided by performing the process explained in FIG. 4 a plurality of times. FIG. 10 is a schematic diagram showing the relationship between a logical address space and physical blocks in such a case.

As shown in FIG. 10, first, eight physical blocks BLK32 to BLK 39 have been set as regular blocks in an expanded area and 32 physical blocks BLK0 to BLK 31 have been set as spare blocks.

In this state, CMD_EAS and CMD_ANR are received, thereby setting physical block BLK71 as a regular block in the expanded area and eight physical blocks BLK72 to BLK79 as spare blocks in the expanded area.

In this case, the allowable number of rewrites of an expanded area of eight physical blocks BLK32 to BLK39 (and 32 spare blocks) is 40,000 times (5,000 times/block). The allowable number of rewrites of an expanded area of one physical block BLK71 (and eight spare blocks) is 7,000 times (7,000 times/block).

2. Effects of the Third Embodiment

As described above, the third embodiment enables a plurality of expanded areas to be set and further the allowable number of rewrites to be set arbitrarily for each expanded area.

### Fourth Embodiment

Next, a memory controller according to a fourth embodiment will be explained. The fourth embodiment is such that the allowable number of rewrites necessary for an expanded area is smaller than an ability value of a physical block in the first embodiment, the modifications of the first embodiment, the second embodiment, or the third embodiment.

1. Operation of Memory Controller 20

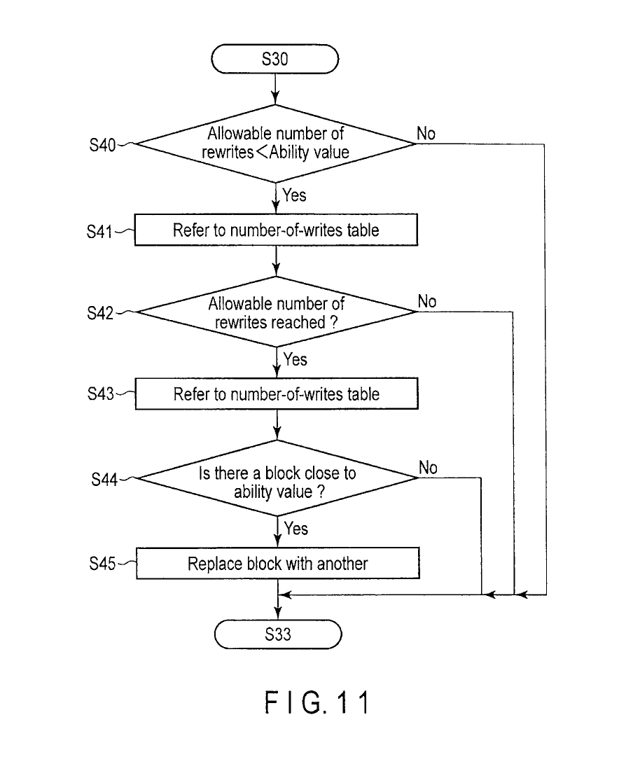

The operation of the memory controller 20 in writing data will be explained with reference to FIG. 11. FIG. 11 is a flowchart to explain the operation of the memory controller 20.

As shown in FIG. 11, when an area to be written into is an expanded area after step S30 explained in FIG. 9, the CPU 24 compares the necessary allowable number of rewrites with an ability value for each regular block in an expanded area (step S40). If the allowable number of rewrites is smaller than the ability value (YES in step S40), the CPU 24 refers to a number-of-writes table (step S41). Then, on the basis of the number-of-writes table, the CPU 24 checks whether the number of writes of an expanded block in the area to be written into has already reached the allowable number of rewrites or is close to the allowable number of rewrites (step S42). To determine whether the number of writes is close to the allowable number of rewrites, the memory controller 20 holds a specific threshold value in the embedded memory 22 and the CPU 24 compares the threshold value with the number of writes. If the number has exceeded the threshold value, the CPU 24 determines that the number of writes is close to the allowable number of rewrites.

If the number of writes of the expanded block has already reached the allowable number of rewrites or is close to the allowable number of rewrites (YES in step S42), the CPU 24 refers to the number-of-writes table (step S43). Then, on the basis of the number-of-writes table, the CPU 24 determines whether there is a physical block whose number of writes is close to an ability value in a normal area or in a regular block in another expanded area (if any) (step S44). In this case, too, the memory controller 20 holds a specific threshold value in the embedded memory 22 and the CPU 24 compares the threshold value with the number of writes. If the number has exceeded the threshold value, the CPU 24 determines that the number of writes is close to the ability value.

If there is a physical block close to the ability value (YES in step S44), the CPU 24 replaces the physical block close to the ability value with a part of or all of the regular blocks and/or spare blocks in an expanded area close to the allowable number of rewrites (step S45). Thereafter, control proceeds to a process in step S33.

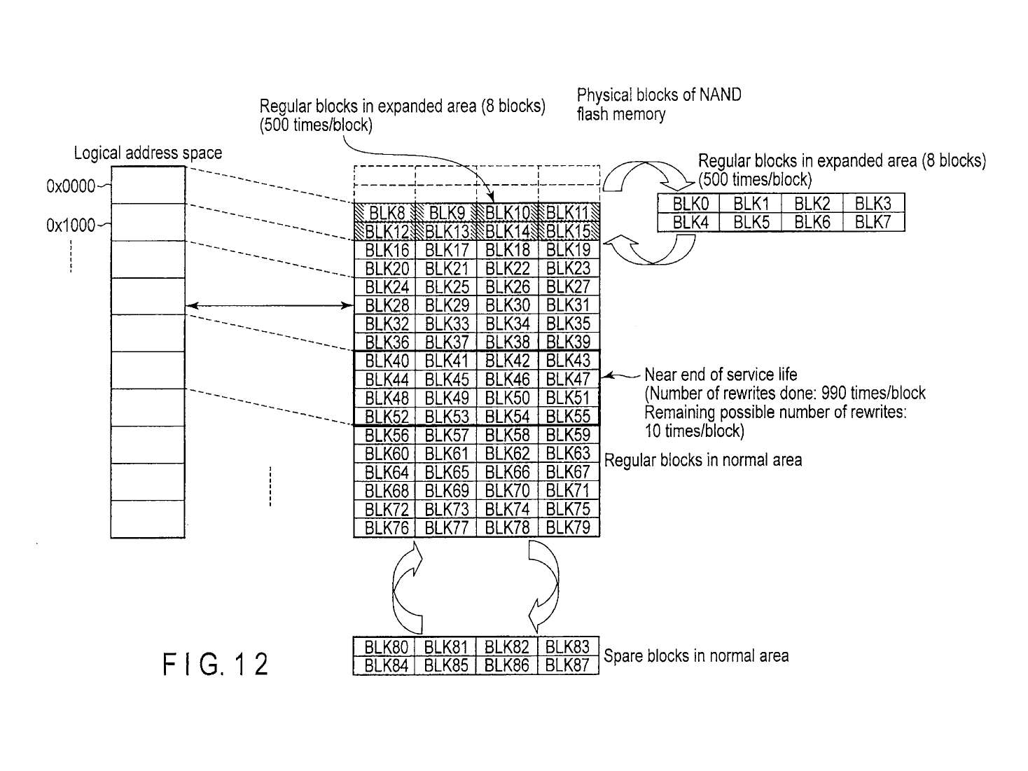

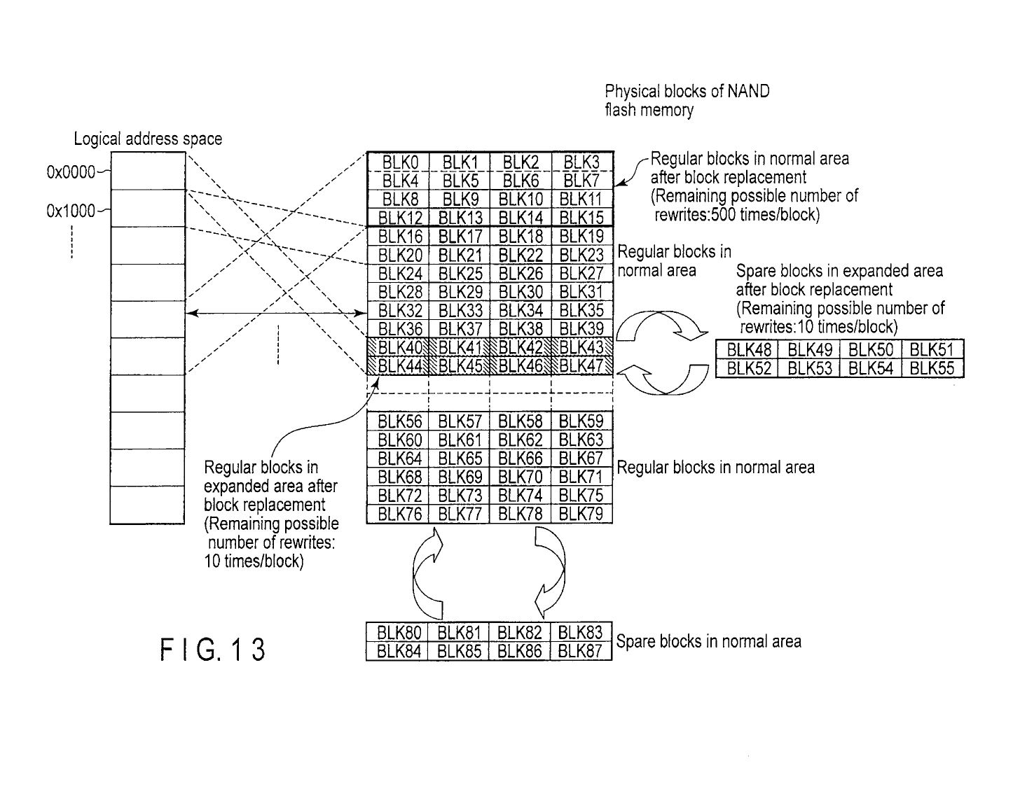

The above specific example will be explained with reference to FIGS. 12 and 13. FIGS. 12 and 13 are schematic diagrams showing the relationship between the logical address space and physical blocks.

In the example of FIG. 12, physical blocks BLK8 to BLK15 are set as regular blocks in an expanded area and physical blocks BLK0 to BLK7 are set as spare blocks in the expanded area. The allowable number of rewrites of the expanded area is 500 times/block. That is, this is smaller than an ability value of 1,000 times. As for each of physical blocks BLK40 to BLK55 in a normal area, its number of rewrites has reached 990 times and the remaining possible number of rewrites is 10 times, that is, comes close to the end of the service life.

In this case, as shown in FIG. 13, the CPU 24 replaces physical blocks BLK0 to BLK15 with physical blocks BLK40 to BLK55. That is, physical blocks BKL0 to BLK15 are set as regular blocks in the normal area in place of physical blocks BLK40 to BLK55. In addition, physical blocks BKL40 to BLK47 are set as regular blocks in the expanded area in place of physical blocks BLK8 to BLK15. Physical blocks BKL48 to BLK55 are set as spare blocks in the expanded area in place of physical blocks BLK0 to BLK7.

2. Effects of the Fourth Embodiment

With the configuration of the fourth embodiment, a NAND flash memory can be used more efficiently.

When the necessary allowable number of rewrites is smaller than an ability value of the allowable number of rewrites per block in an expanded area, it can be determined that a physical block in the expanded area has been used wastefully at the time that the number of times data was written has reached the necessary allowable number of rewrites.

Therefore, in the fourth embodiment, if there is another block close to the end of the service life near an ability value, replacing the physical block with the wastefully-used block makes it possible to increase the number of rewrites in a logical address space to which the block close to the end of the service life was allocated.

In the example of FIG. 12, although the ability value of a physical block is 1,000 times/block, if rewriting can be performed 500 times/block in an expanded area, this satisfies the requirement. This means that the remaining 500 rewrites have been wasted.

Therefore, as shown in FIG. 13, the CPU 24 replaces physical blocks BLK40 to BLK55 which have already been rewritten 990 times and are close to the end of their service life with physical blocks BLK0 to BLK15 in an expanded area. This increases the remaining possible number of rewrites in the logical address space to which physical blocks BLK40 to BLK55 were allocated from 10 times/block (=1,000 times−990 times) before replacement to 500 times/block (1,000 times−500 times).

Although the remaining possible number of rewrites in the expanded area decreases to 10 times, the expanded area has already reached the allowable number of rewrites (500 times/block) or is close to the allowable number of rewrites. Therefore, this does not become a problem.

At this time, when the expanded area has not reached the allowable number of rewrites, it is desirable that the remaining possible number of rewrites should be less than or equal to the remaining number of rewrites in a normal area to be replaced.

### Modifications and Others

As described above, the memory controller according to the fourth embodiment includes a first interface (host I/F 21 in FIG. 1), a second interface (memory I/F 23 in FIG. 1), and a control module (CPU 24 in FIG. 1). The first interface transmits and receives a signal to and from a host (host 10 in FIG. 1). The second interface transmits and receives a signal to and from a nonvolatile semiconductor memory (NAND 30 in FIG. 1). In response to a first command (CMD_EAS and CMD_ANR in FIG. 4) received by the first interface, the control module reserves a spare area (spare block in FIG. 5) in a semiconductor memory and writes update data in the spare area when updating data in the semiconductor memory. The size of the spare area can be varied according to a first command (S14 in FIG. 4).

With this configuration, it is possible to set a just enough spare area, while setting the number of rewrites arbitrarily. As a result, the memory space of the semiconductor memory can be used efficiently.

The embodiments are not limited to what have been explained above and may be modified in still other ways. For example, the semiconductor memory controlled by the memory controller 20 is not limited to a NAND flash memory and may be other semiconductor memories in general, including a NOR flash memory, an AND flash memory, a magnetic random-access memory (MRAM), a ferroelectric memory (ferroelectric RAM), and a resistive RAM (ReRAM).

Furthermore, in the above embodiments, an area where each memory cell holds multibit data greater than or equal to two bits of data has been defined as a normal area and an area where each memory cell holds one-bit data has been defined as an expanded area. However, data is not limited to these numbers of bits. For example, both a normal area and an expanded area may hold multibit data greater than or equal to two bits of data. In this case, the number of bits each memory cell in an expanded area can hold may be made smaller than the number of bits each memory cell in a normal area can hold. Of course, this relationship may be reversed. Then, variable B in equation (1) may be varied according to the number of bits a memory cell can hold. As an example, when a memory cell in an expanded area holds one bit data, B may be set as B=10,000. When the memory cell holds multibit data, B may be set as B=1,000. Whether to hold 1-bit data or multibit data can be set by, for example, CMD_EAS and/or CMD_ANR. In addition, when a plurality of expanded areas are provided, the number of bits of memory cell in each region can hold may be changed. For example, each memory cell in a normal area may hold 3-bit data, each memory cell in an expanded area may hold 1-bit data, and each memory cell in another expanded area may hold 2-bit data. Alternatively, each memory cell in a normal area may hold 2-bit data and each memory cell in two or more expanded areas may hold 1-bit data. A normal area does not necessarily differ from an expanded area in the number of bits a memory cell is caused to hold. That is, the number of bits of data each memory cell in a normal area can hold may be equal to the number of bits of data each memory cell in an expanded area can hold. In this case, each memory cell in a normal area and each memory cell in an expanded area may hold 1-bit data or both may hold multibit data. The way to use a normal area may be made different from the way to use an expanded area according to the difference in other various characteristics, not to the number of bits.

A part of or all of the functions performed by the memory controller explained in the embodiments may be implemented in the semiconductor memory or in the host device.

Furthermore, the equation to calculate the number of spare blocks is not limited to equation (1) explained in the embodiment. Subtraction, addition, multiplication, and/or division may be added, provided that the number of necessary spare blocks can be calculated. The aforementioned flowcharts are not limited to the sequences shown in the figures. The sequences may be changed as much as possible. Alternatively, a plurality of processes may be performed simultaneously.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory controller comprising:
a first interface which transmits and receives a signal to and from a host;
a second interface which transmits and receives a signal to and from a nonvolatile semiconductor memory; and
a control module which reserves a spare area in the semiconductor memory in response to a first command received by the first interface and writes update data into the spare area when updating data in the semiconductor memory,
wherein size of the spare area is variable according to the first command.

2. The controller according to claim 1, wherein the first command includes information on the allowable number of rewrites of the semiconductor memory, and the control module determines the size of the spare area based on the information.

3. The controller according to claim 2, wherein the semiconductor memory includes a plurality of blocks each serving as an erase unit, the blocks including a plurality of memory cells each holding data,
the control module reserves a first area in the semiconductor memory in response to the first command and uses the spare area when updating data in the first area,
the information included in the first command is information on the allowable number of rewrites required for the first area, and
the control module calculates the number of blocks X in the spare area using the following equation:
X=A(C−B)/B,
where A indicates the number of blocks in the first area, B indicates the allowable number of rewrites per block, and C indicates the allowable number of rewrites required for the first area.

4. The controller according to claim 3, wherein a memory cell included in the first area and the spare area of the first area in the semiconductor memory is capable of holding one bit data and a memory cell included in other area is capable of holding two or more bits data.

5. The controller according to claim 3, wherein a memory cell is capable of holding multibit data.

6. The controller according to claim 5, wherein the number of bits of data a memory cell included in the first area and the spare area of the first area is capable of holding differs from the number of bits of data a memory cell included in other area is capable of holding.

7. The controller according to claim 5, wherein the number of bits of data a memory cell included in the first area and the spare area of the first area is capable of holding is smaller than the number of bits of data a memory cell included in other area is capable of holding.

8. The controller according to claim 5, wherein the number of bits of data a memory cell included in the first area and the spare area of the first area is capable of holding is equal to the number of bits of data a memory cell included in other area is capable of holding.

9. The controller according to claim 3, wherein the control module records the number of writes for each of the blocks in a table, and
when the number of writes of a block has reached the number B, the control module inhibits the block from being written into.

10. The controller according to claim 9, wherein the control module sets a flag in an entry of the table corresponding to the block which has reached the number B.

11. The controller according to claim 3, wherein the control module replaces a first block in the first area with a second block in other area based on the number of writes of the block.

12. The controller according to claim 11, wherein the control modules, when C<B, replaces a block which has reached the number B in the first area with a block which is close to the number C in other area.

13. The controller according to claim 12, wherein the control module records the number of writes for each of the blocks in a table, and
whether or not a block is close to the number B is determined by comparing the number of writes recorded in the table with a specific threshold value.

14. A method of controlling a semiconductor memory device which includes a plurality of blocks, comprising:
receiving a first command and a second command, the first command requesting the semiconductor memory device to set a first area, and the second command including information on the allowable number of rewrites required for the first area;
reserving an A number of blocks as regular blocks in the first area in response to the first command; and
reserving an X number of blocks as spare blocks in the first area in response to the second command, the spare blocks being used in updating data in the regular blocks,
wherein the number of spare blocks is determined based on the allowable number of rewrites.

15. The method according to claim 14, wherein the number of blocks X in the spare area is calculated using the following equation:
X=A(C−B)/B
where B is the allowable number of rewrites per block and C is the allowable number of rewrites required for the first area.

16. The method according to claim 14, wherein a memory cell in the first area is capable of holding one bit data and a memory cell in other area is capable of holding two or more bits data.

17. The method according to claim 15, further comprising:
recording the number of writes for each of the blocks in a table; and
when the number of writes of a block has reached the number B, inhibiting the block from being written into.

18. The method of claim 15, further comprising:
when C<B, replacing a block which has reached the number B in the first area with a block which is close to the number C in other area.
